(19) United States
(12) Patent Application Publication
(10) Pub. No.: US 2025/0150626 A1
(43) Pub. Date: May 8, 2025

(54) BLOCK-BASED COMPRESSION AND LATENT SPACE INTRA PREDICTION

(71) Applicant: InterDigital VC Holdings, Inc., Wilmington, DE (US)

(72) Inventors: Hyomin CHOI, Los Altos, CA (US); Fabien RACAPE, Los Altos, CA (US); Simon FELTMAN, Los Altos, CA (US)

(21) Appl. No.: 18/832,455

(22) PCT Filed: Dec. 7, 2022
(86) PCT No.: PCT/US2022/052160

§ 371 Date: Jul. 23, 2024

Related U.S. Application Data
(60) Provisional application No. 63/302,592, filed on Jan. 25, 2022.

(51) Int. Cl. H04N 19/60; H04N 19/105; H04N 19/176

(52) U.S. Cl. CPC H04N 19/60; H04N 19/105; H04N 19/176

(57) ABSTRACT

In one implementation, we propose a block-based end-to-end image and video compression method that takes non-overlapping or overlapping split blocks of input images or frames of videos as input. Then, the proposed decoder network reconstructs non-overlapped split blocks of the input. We also introduce an intra prediction method to reduce spatial redundancy in the latent space, i.e., one or more previously decoded latent tensors from neighboring blocks are used as references to predict the current block's latent tensor. Additionally, the decoder can selectively complete the pixel reconstruction process for decoded latent blocks without causing any error drift to neighboring blocks since the prediction is made in the latent space. Enabling and disabling the pixel reconstruction can be signaled by the encoder as metadata in the bitstream or decided at the decoding stage using a computer vision task.

### TECHNICAL FIELD

The present embodiments generally relate to a method and an apparatus for compression of images and videos using Artificial Neural Network (ANN)-based tools.

### BACKGROUND

In recent years, novel image and video compression methods based on neural networks have been developed. Contrary to traditional methods which apply pre-defined prediction modes and transforms, ANN-based methods rely on many parameters that are learned on a large dataset during a training stage, by iteratively minimizing a loss function. In the case of compression, the loss function is, for example, defined by the rate-distortion cost, where the rate stands for the estimation of the bitrate of the encoded bitstream and the distortion quantifies the quality of the decoded video against the original input. Traditionally the quality of the decoded input image is optimized, for example, based on the measure of the mean squared error or an approximation of the human-perceived visual quality.

The Joint Video Exploration Team (JVET) between ISO/MPEG and ITU is currently studying ANN-based tools to replace some modules of the latest video coding standard H.266/VVC, as well as the replacement of the whole structure by end-to-end auto-encoder methods.

### SUMMARY

According to an embodiment, a method of video decoding is presented, comprising: decoding a residue block in a latent space for a block of a picture; obtaining a predicted latent block for said block, based on one or more neighboring blocks; obtaining a latent block for said block, based on said residue block and said predicted latent block; and inverse transforming said latent block for said block to reconstruct said block in a pixel domain.

According to another embodiment, a method of video encoding is presented, comprising: transforming a block of a picture into a latent block in a latent space for said block; obtaining a predicted latent block for said block, based on one or more neighboring blocks; obtaining a residue block for said block in said latent space, based on said predicted latent block for said block and said latent block; and encoding said residue block for said block.

According to another embodiment, an apparatus for video decoding is presented, comprising one or more processors and at least one memory coupled to said one or more processors, wherein said one or more processors are configured to decode a residue block in a latent space for a block of a picture; obtain a predicted latent block for said block, based on one or more neighboring blocks; obtain a latent block for said block, based on said residue block and said predicted latent block; and inverse transform said latent block for said block to reconstruct said block in a pixel domain.

According to another embodiment, an apparatus for video encoding is presented, comprising one or more processors and at least one memory coupled to said one or more processors, wherein said one or more processors are configured to transform a block of a picture into a latent block in a latent space for said block; obtain a predicted latent block for said block, based on one or more neighboring blocks; obtain a residue block for said block in said latent space, based on said predicted latent block for said block and said latent block; and encode said residue block for said block.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for encoding or decoding video data according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 shows an example of an end-to-end compression system.

FIG. 3 illustrates the input image X with the blocks of pixels X_{(i,j)}.

FIG. 4 illustrates an end-to-end compression system, according to an embodiment.

FIG. 5 presents the encoding and decoding process for the rest of blocks Xi,j.

FIG. 6 illustrates prediction of the current latent block from a left neighboring block.

FIG. 7A illustrates prediction of the current latent block from the entire left neighboring block, and FIG. 7B illustrates prediction of the current latent block from a part of the left neighboring block.

FIG. 8 shows an example of the prediction process.

FIG. 9 illustrates prediction of the current latent block from a top neighboring block.

FIG. 10A illustrates prediction of the current latent block from the entire top neighboring block, and FIG. 10B illustrates prediction of the current latent block from a part of the top neighboring block.

FIG. 11 shows another example of the prediction process.

FIG. 12 illustrates prediction of the current latent block from a top, left and top-left neighboring block.

FIG. 13A illustrates prediction of the current latent block from the entire top, left and top-left neighboring blocks, and FIG. 13B illustrates prediction of the current latent block from a part of the top, left and top-left neighboring blocks.

FIG. 14 shows another example of the prediction process.

FIG. 15 illustrates a decoder system of block-based end-to-end compression with latent space intra prediction, according to an embodiment.

FIG. 16 shows an example of avoiding the reconstruction of some blocks in the pixel domain.

### DETAILED DESCRIPTION

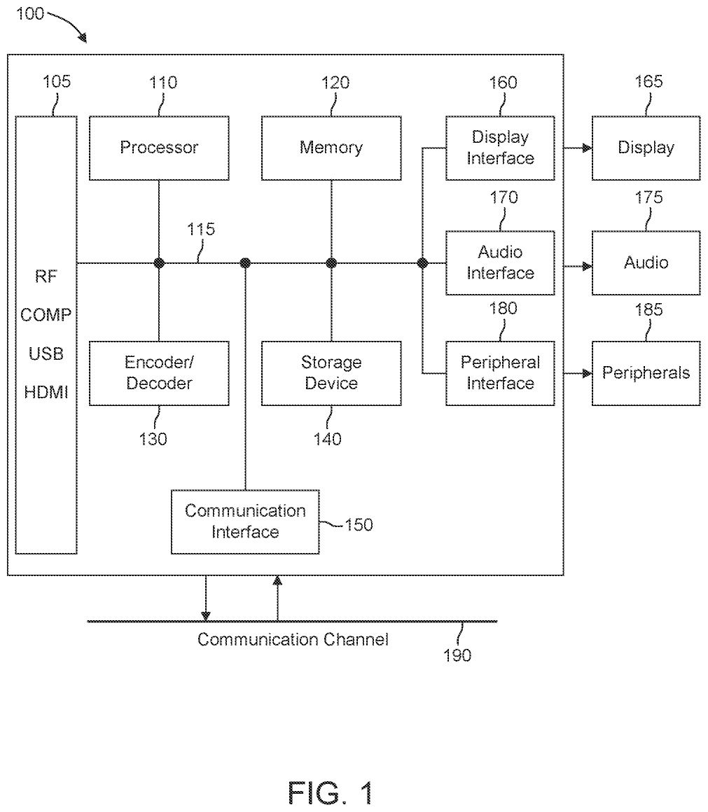

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802. 11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

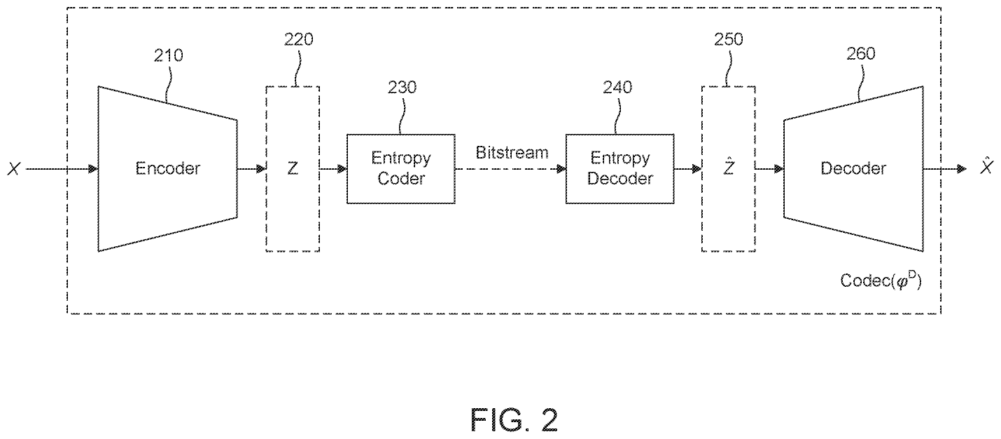

FIG. 2 shows an example of an end-to-end neural network-based compression system. In this end-to-end neural network-based compression system, the training is done for the entire system (the loss function is based on the difference between input X and output \hat{X}). Input X to the encoder part of the network can include:
an image or frame of a video,
a part of an image,
a tensor representing a group of images,
a tensor representing a part (crop) of a group of images.

In each case, the input can have one or multiple components, e.g., monochrome, RGB or YCbCr components. As shown in FIG. 2, input tensor X is fed into the encoder network (210). The encoder network is usually a sequence of convolutional layers with activation functions. Large strides in the convolutions or space-to-depth operations can be used to reduce spatial resolution while increasing the number of channels. The encoder network can be seen as a learned transform. Note that the space-to-depth operations can be implemented by reshaping and permutation, for example a tensor of size (N, H, W) is reshaped and permuted to (N*2*2, H/2, W/2).

The output of the encoder network, the “deep features map” or “latent” Z (220), is quantized and entropy coded (230) as a binary stream (bitstream) for storage or transmission.

At the decoding side, the bitstream is entropy decoded (240) to obtain \hat{Z} (250), the quantized version of Z. The decoder network (260) generates \hat{X}, an approximation of the original X tensor from latent \hat{Z}. The decoder network is usually a sequence of up-sampling convolutions (e.g., “deconvolutions” or convolutions followed by up-sampling filters) or depth-to-space operations. The decoder network can be seen as a learned inverse transform, or a denoising and generative transform.

More specifically, the encoder network is usually composed of a sequence of convolutional layers with stride, allowing to reduce spatial resolution of the input while increasing the depth, i.e., the number of channels of the input. Squeeze operations can also be used instead of stride convolutional layers (space-to-depth via reshaping and permutations). The encoder network can be seen as a learned transform.

The output of the analysis, mostly in the form of 3-way array, referred to as 3-D tensor is called latent or deep feature maps. From a broader perspective, a set of latent variables constructs a latent space, which is also frequently used in the context of neural network-based end-to-end compression.

The latent is quantized and entropy coded for storage/transmission, as depicted in FIG. 2. The bitstream, i.e., the set of coded syntax elements and payloads of bins representing the quantized symbols, is transmitted to the decoder.

The decoder first decodes quantized symbols from the bitstream. The decoded latent tensor is then transformed into pixels for output through a set of layers usually composed of (de-)convolutional layers (or depth-to-space squeeze operations). The decoder network is thus a learned inverse transform operating on quantized coefficients. The output of the decoder is the reconstructed image or a group of images \hat{X}.

Note that more sophisticated architectures exist, for example, adding a “hyper-autoencoder” (hyper-prior) to the network to jointly learn the latent distribution properties of the encoder output. The present principles are not limited to the use of autoencoders. Any end-to-end differentiable codec can be considered.

Despite there is no restriction on the input format of the autoencoders as stated earlier, most existing approaches take an entire image or frame as input to transform into latent Z as presented in FIG. 2. At such cases, the latent represents a 3-dimensional tensor of transformed feature information from the input image gone through (non-)linear transformation with a number of convolutional layers followed by activation. It implies that spatial redundancy is decomposed solely through the learned transformation operation, which limits not only the coding efficiency, but also the application of compression.

The present embodiments aim at not only optimizing rate-distortion for compressed image and video with a block-based approach with a new intra prediction method in the latent space, but also at providing potential application use of block-based end-to-end image and video compression.

Since most state-of-the-art end-to-end image compression methods process entire images through learned non-linear transformations, there is no other way to reduce spatial redundancy but learn global optimal transforms to de-correlate the input content. The whole image being transformed and compressed through a learned network, it is challenging to control the quality of the reconstructed input locally.

On the contrary, traditional hybrid encoders partition images into non-overlapping blocks of different sizes to spatially adapt to the content. They can then make decisions on prediction modes and transforms at the block level to minimize spatial redundancies from the rate-distortion optimization perspective. Furthermore, when using block-based coding, regions of interest can be adaptively coded with adaptive quality.

In this application, we first propose a block-based end-to-end image compression method that takes non-overlapping or overlapping split blocks of input images or frames of videos as input to be coded. Then, the proposed decoder network reconstructs non-overlapped split blocks of the input.

We also introduce an intra prediction method to reduce spatial redundancy in the latent space, denoted Z as shown in FIG. 2. A mechanism like intra frame prediction is applied in the latent space, i.e., previously decoded latent tensors from neighboring blocks are used as references to predict the current block's latent tensor.

Additionally, the decoder can selectively complete the pixel reconstruction process for decoded latent blocks without causing any error drift to neighboring blocks since the prediction is made in the latent space. Enabling and disabling pixel reconstruction can be signaled by the encoder as metadata in the bitstream or decided at the decoding stage.

As previously explained, traditional image/video coding encoders partition input images into large blocks, also called Coding Tree Units (CTUs). Each of these CTUs are then sub-partitioned into smaller sub-blocks, depending on the effectiveness of the prediction and transforms to remove the redundancies in local textures. Each sub-block is coded using a prediction mode selected by the encoder among pre-defined normative modes, fixed linear transforms (e.g., DCT-II) and quantization, minimizing a rate-distortion criterion. Those processes make image/video coding very flexible in terms of local optimization with respect to bitrate and distortion.

Most end-to-end compression methods compress entire input images at once with learned analysis and synthesis nonlinear transforms. Particularly, these methods do not include adaptability mechanisms such as prediction modes and various quantization steps. Therefore, compression performance is solely dependent on behavior of the learned nonlinear transform. Since entire input images are processed by a unique learned transform, there is not much flexibility left to adapt the quality of decoded regions of interest. It is well known to generate adaptive output results with the end-to-end compression methods in a way that applies several pre-trained transforms to the input until the output meets desired criteria. Yet, in most state-of-the-art end-to-end compression methods, a unique pre-trained transform is applied to the entire images for each input image or video.

Some solutions have been proposed, like conditioning the transforms by rescaling the intermediary feature maps with learned coefficients (by layers) or learning normalization layers per bitrate and switching them on the fly. However, this is limited to the use case of targeting specific bitrates using the same model and can only affect the scaling of the feature maps, with would have limited effects in improving the compression efficiency.

In addition, such a block-based process enables lower-end decoders to process images block by block which can reduce the required memory for processing, as well as the latency for some applications.

In this application, we propose a block-based end-to-end image and video compression method that provides flexibility at the block level to reconstruct pixels while our proposed intra prediction refers to neighboring blocks to predict the current block in the latent space to reduce spatial redundancy. The architecture of the auto-encoders used to compress each block can follow any of the existing end-to-end compression methods that rely on the generation of a latent space compressible representation of the input pixels.

By introducing latent space intra prediction in block-based end-to-end compression, there may be output bits reduction by decreasing spatial redundancy with the proposed prediction method. Additionally, adaptive block reconstruction can be achieved upon the block-based compression architecture.

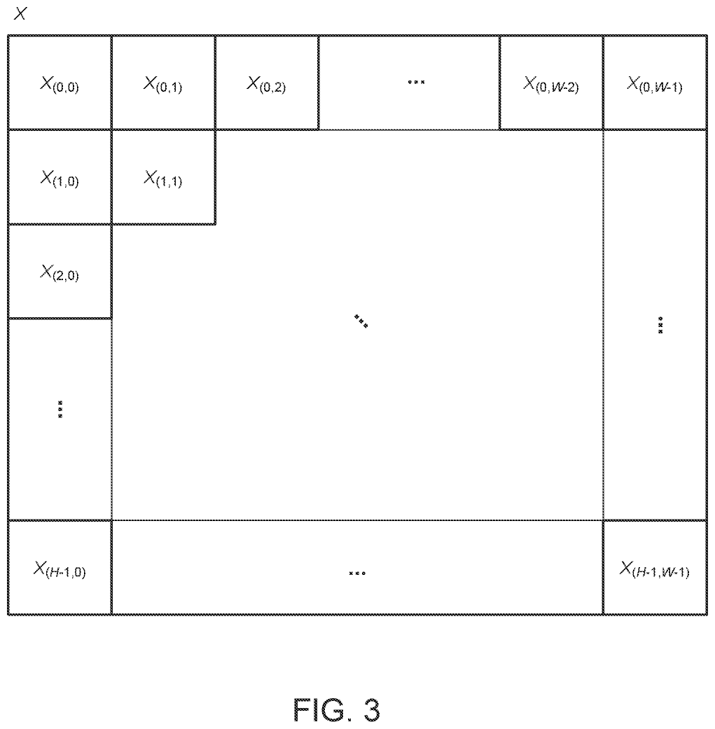

Let X be the input image, then X_{(i,j)} is a block of pixels where i and j represent column and row of the block location as shown in FIG. 3. Our block-based end-to-end compression (de)codes each block X_{(i,j)} in a raster scan order as an example, but the present principles are not limited to the specific scanning order.

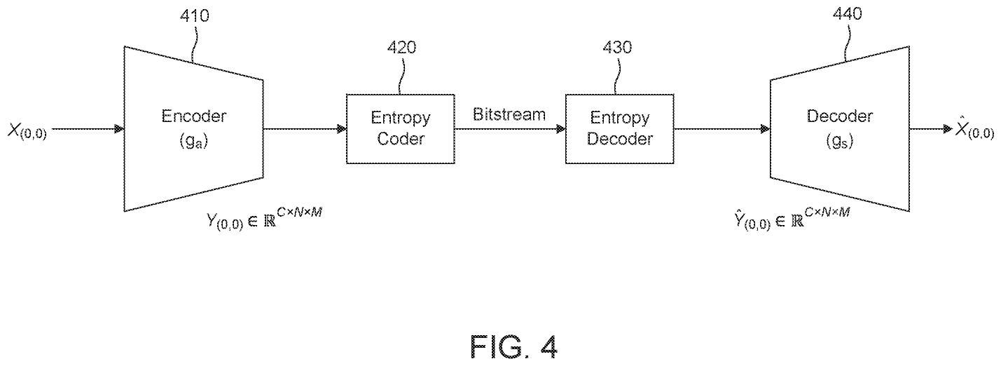

In FIG. 4, let us note gₐ( ) the analysis transform (encoder, 410), gₛ( ) the synthesis transform (decoder, 440), X_{(0,0)} the first block of the input image at top-left corner, Y_{(0,0)} the latent corresponding to the first input block, and Ŷ_{(0,0)} the reconstructed latent. Entropy coder (420) may or may not include a quantization process to binarize the given latent and write a bitstream, and entropy decoder (430) does an inverse process of entropy coder (420) to reconstruct Ŷ_{(0,0)}. There is no architectural difference of neural network transformers between the frame-based and block-based one. The only difference can be found in boundary padding options. For the block-based coding method, a padding operation that replicates boundary pixels can be used if padding is needed, which depends on the size of kernels for convolutional layers. A basic process of end-to-end compression for the first block can be expressed as:

$${g}_{a} ( {X}_{( 0 , 0 )} ) = {\hat{Y}}_{( 0 , 0 )}$$

$${g}_{s} ( {\hat{Y}}_{( 0 , 0 )} ) = {\hat{X}}_{( 0 , 0 )}$$

Additional neural networks such as hyper-prior encoder/decoder and auto-regression models can further process the latent in order to improve coding efficiency. Depending on the size of the block to split an input image, the size of latent block varies. As shown in an example in FIG. 4, the size of the latent Y_{(0,0)} is defined as C×N×M where C represents number of channels of the latent and N×M indicates the resolution of each channel.

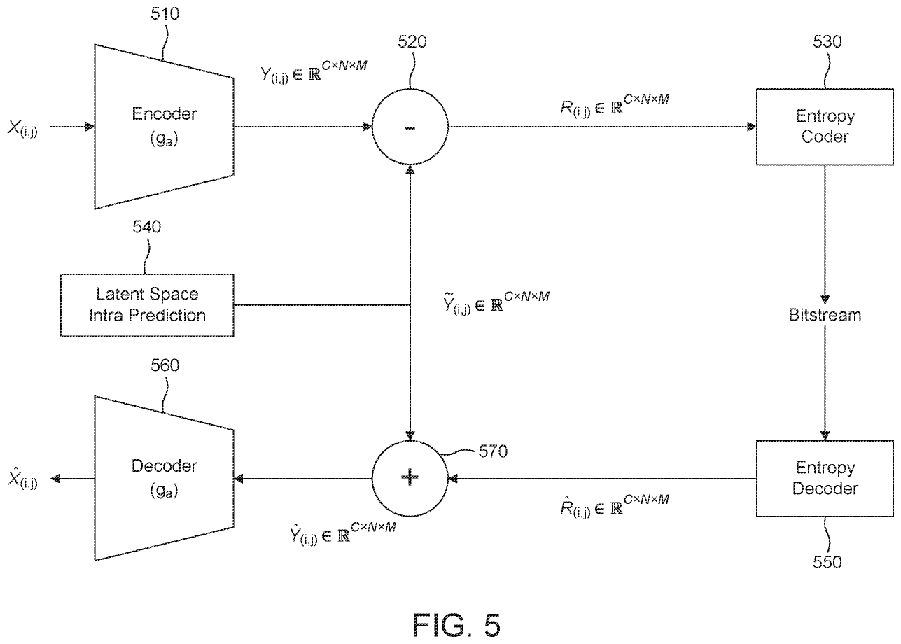

FIG. 5 presents the encoding and decoding process for the rest of blocks X_{(i,j)} where i and j are not 0, according to an embodiment. Those blocks are transformed (510) to latent using the same transformers gₐ( ) or others. To reduce the redundant information from previously coded latent blocks, we propose a latent space intra prediction method (540) that estimates the current coding latent Y_{(i,j)} from neighboring latents. Therefore, the transformed latent Y_{(i,j)} from the input block X_{(i,j)} is subtracted (520) by a predictor \tilde{Y}_{(i,j)}, then residual latent R_{(i,j)} is coded with entropy coder (530). Like the additional operation for the first latent block, R_{(i,j)} can be further processed with hyper-prior and/or any auto-regression models. At the decoder, latent space intra prediction (540) still generates the predictor \tilde{Y}_{(i,j)}) by referencing decoded neighboring latents. Hence the residual \hat{R}_{(i,j)} decoded by entropy decoder (550) is added (570) to \tilde{Y}_{(i,j)} to reconstruct Ŷ_{(i,j)}. Finally, gₛ( ) or other reconstruction network (560) take Ŷ_{(i,j)} as input to reconstruct \hat{X}_{(i,j)}.

As described above, we propose latent space intra prediction to reduce the redundancy between latent space representations of neighboring blocks. In the following, we describe three possible latent prediction modes, depending on available neighboring decoded information.

### Horizontal Prediction

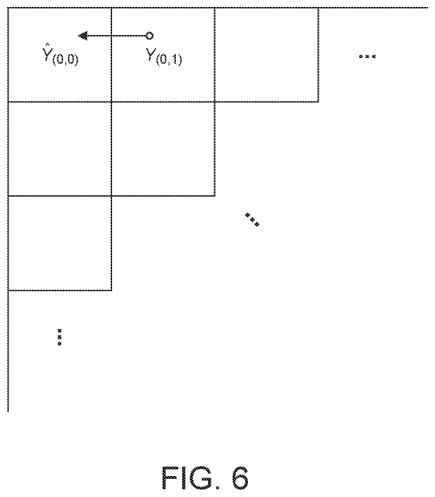

In the first case, the current coding latent block Y_{(0,1)} refers to left neighboring latent block Ŷ_{(0,0)} as indicated by the arrow, as shown in FIG. 6.

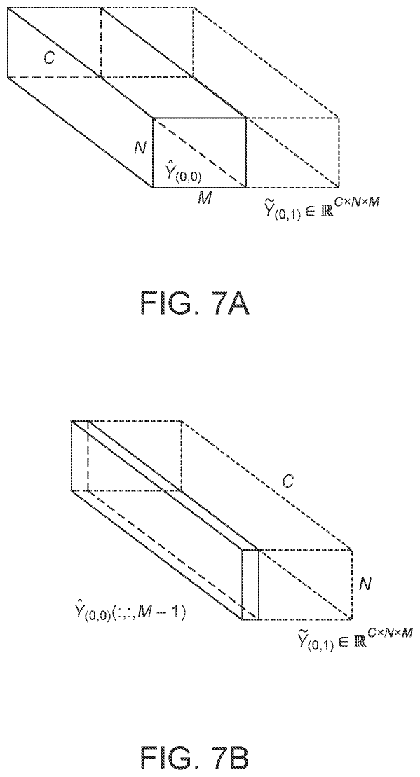

FIG. 7A presents the latent blocks in 3-dimension with the size of C×N×M. Specifically, our latent space intra prediction generates a predictor \tilde{Y}_{(0,1)} by referencing to the left latent block Ŷ_{(0,0)}. Previously decoded Ŷ_{(0,0)} is available at both encoder and decoder when (de)coding the latent block at (0,1).

In one embodiment, part of Ŷ_{(0,0)}, rather than whole latent elements, can be used as reference in the consideration of computational efficiency in terms of the number of samples to buffer and the number of multiplications. For example, as presented in FIG. 7B, the closest relevant reference samples, Ŷ_{(0,0)}(:,:, M−1), can be used as reference to produce \tilde{Y}_{(0,1)} using (non-)linear computation with or without associating with trainable variables.

A simple way to generate predicted latent elements of \tilde{Y}_{(0,1)} is to apply fully connected layers followed by activation functions for 1-d vectorized input of Ŷ_{(0,0)}(:,:, M−1). An alternate is to use convolutional layers to utilize the advantage of parallel computation.

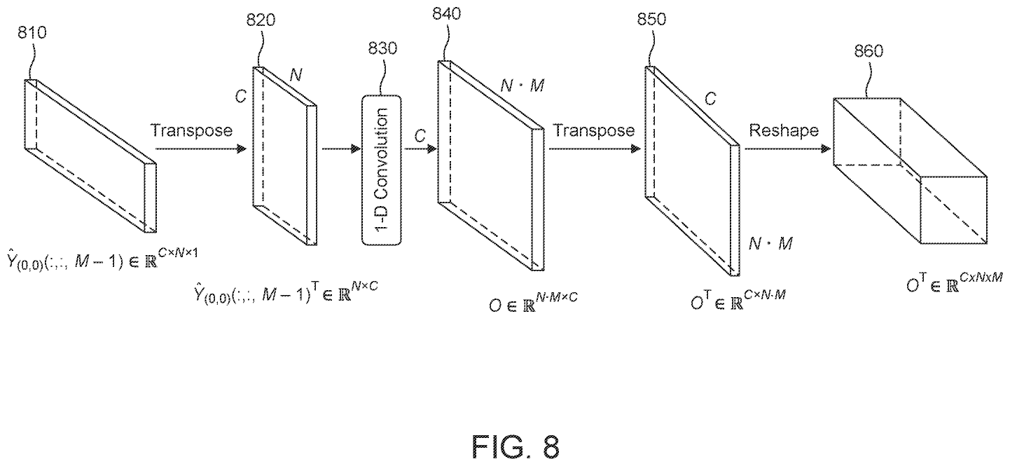

FIG. 8 shows an example of the prediction process with Ŷ_{(0,0)}(:,:, M−1) as input. Considering the behavior of a convolutional layer that generates multiple channels with trained kernels at output, the reference latent Ŷ_{(0,0)}(:,:, M−1)∈ [symbol] ^{C×N×1} (810) is transposed to [symbol] ^{N×C} (820) to be used as input to the 1-D convolutional layer with 1×1 kernel (830) for N·M output channels. The convolutional operation for the output value of the layer can be described as:

$$O ( k ) = bias ( k ) + {\sum }_{n = 0}^{N} w ( k , n ) ○ ⋆ input ( n )$$

Where k=0, . . . N·M−1. Once the convolutional operation is done, we have O∈ [symbol] ^{N·M×C} (840). Back to the original shape of tensor latent, the output is transposed (850) again then reshaped to O^{T}∈ [symbol] ^{C×N×M} (860) as presented in FIG. 8. This output can be \tilde{Y}_{(0,1)} or further processed with typical 2-D convolutional layers followed by an activation function.

The present principles are not limited to use only Ŷ_{(0,0)}(:,:, M−1) as input. Additional information such as location information, e.g., distance between the reference samples and the current latent block, or horizontal and vertical coordinates of the reference samples can be added as an extra channel to the input.

### Vertical Prediction Only

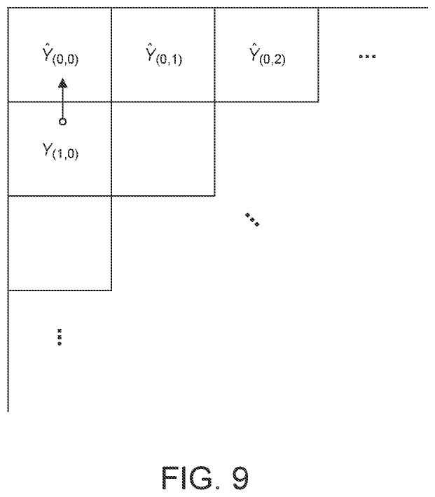

The second embodiment is a case when the current coding latent block Y_{(1,0)} refers to above neighboring latent block Ŷ_{(0,0)} as indicated by the arrow shown in FIG. 9.

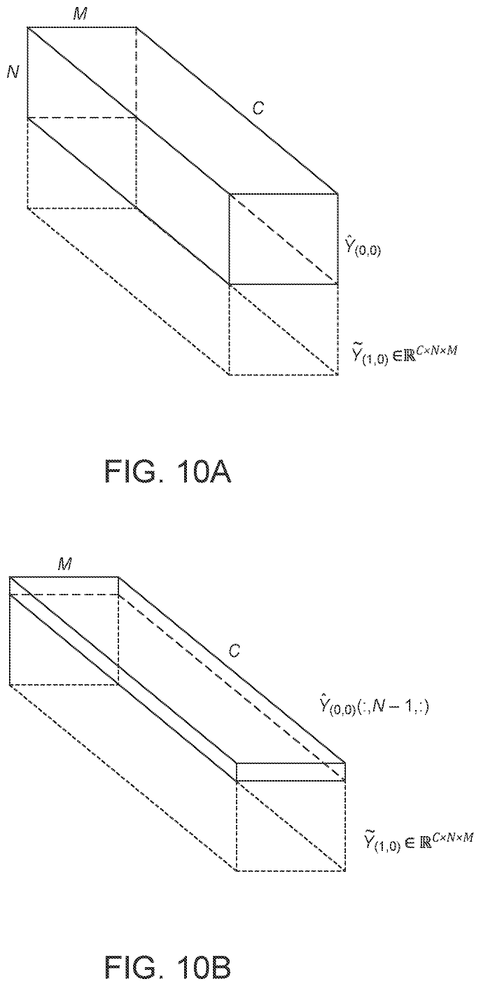

FIG. 10A presents the latent block in 3-dimension with the size of C×N×M. Specifically, our latent space intra prediction generates a predictor \tilde{Y}_{(1,0)} by referencing to the above latent block Ŷ_{(0,0)}. Previously decoded Ŷ_{(0,0)} is available at both encoder and decoder when (de)coding the latent block at (1,0).

In one embodiment, part of Ŷ_{(0,0)}, rather than whole latent elements, can be used as reference in the consideration of computational efficiency in terms of the number of samples to buffer and the number of multiplications. For example, as presented in FIG. 10B, the closest relevant reference samples, Ŷ_{(0,0)}(:, N−1, :), can be used as reference to produce \tilde{Y}_{(1,0)} using (non-)linear computation with or without associating with trainable variables.

A simple way to generate predicted latent elements of \tilde{Y}_{(1,0)} is to apply fully connected layers followed by activation functions for 1-d vectorized input of Ŷ_{(0,0)}(:, N−1, :). An alternate is to use convolutional layers to utilize the advantage of parallel computation.

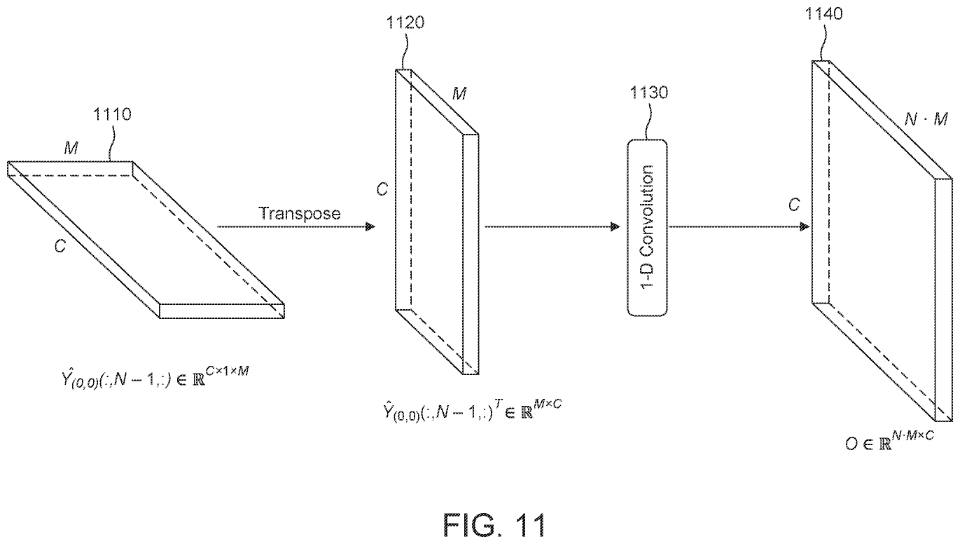

FIG. 11 shows an example of the prediction process with Ŷ_{(0,0)}(:, N−1, :) as input. Considering the behavior of a convolutional layer that generates multiple channels with trained kernels at output, the reference latent Ŷ_{(0,0)}(:, N−1, :)∈ [symbol] ^{C×1×M} (1110) is transposed to [symbol] ^{M×C} (1120) to be used as input to the 1-D convolutional layer with 1×1 kernel (1130) for N·M output channels. The convolutional operation for the output value of the layer can be described as:

$$O ( k ) = bias ( k ) + {\sum }_{n = 0}^{N} w ( k , n ) ○ ⋆ input ( n )$$

where k=0, . . . N·M−1. Once the convolutional operation is done, we have O∈ [symbol] ^{N·M×C} (1140). Back to the original shape of tensor latent, the output is transposed again then reshaped to O^{T}∈ [symbol] ^{C×N×M} as presented in FIG. 8. This output can be \tilde{Y}_{(1,0)} or further processed with typical 2-D convolutional layers followed by an activation function.

The present principles are not limited to use only Ŷ_{(0,0)}(:, N−1, :) as input. Additional information such as location information of the reference samples can be added as extra channels to the input.

### Prediction with Top, Left and Top-Left Blocks

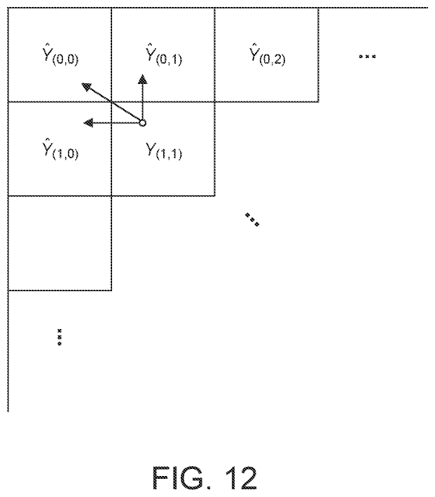

In the third embodiment, the current coding latent block Y_{(1,1)} refers to three neighboring latent blocks: the left Ŷ_{(1,0)}, the above Ŷ_{(0,1)} and the diagonal Ŷ_{(0,0)} as indicated by the arrows shown in FIG. 12.

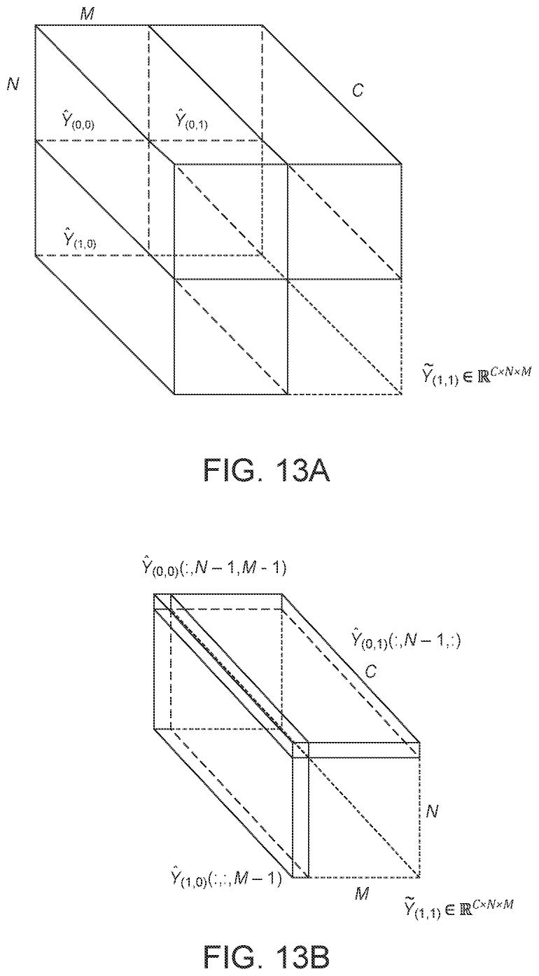

FIG. 13A presents the latent block in 3-dimension with the size of C×N×M. Specifically, our latent space intra prediction generates a predictor \tilde{Y}_{(1,1)} by referencing to all three latent blocks of the left Ŷ_{(1,0)}, the above Ŷ_{(0,1)} and the diagonal Ŷ_{(0,0)}. Previously decoded Ŷ_{(1,0)}, Ŷ_{(0,1)} and Ŷ_{(0,0)} are available at both encoder and decoder when (de)coding the latent block at (1,1).

In one embodiment, part of the neighboring latent blocks, rather than whole latent blocks, can be used as reference in the consideration of computational efficiency in terms of the number of samples to buffer and the number of multiplications. For example, as presented in FIG. 13B, the closest relevant reference samples, Ŷ_{(1,0)}(:,:, M−1) from the left, Ŷ_{(0,1)}(:, N−1, :) from the above, and Ŷ_{(0,0)}(:, N−1, M−1) from the diagonal, can be used as reference to produce \tilde{Y}_{(1,1)} using (non-)linear computation with or without associating with trainable variables.

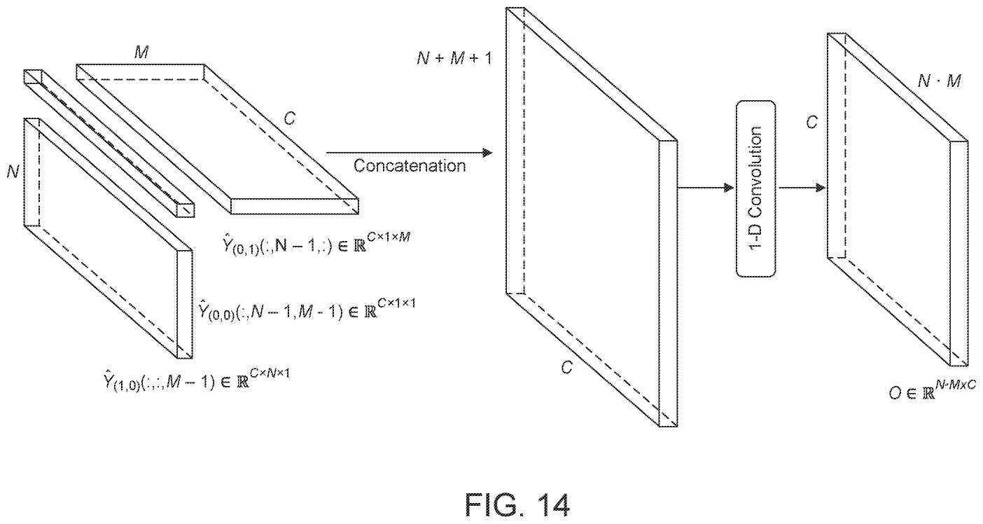

A simple way to generate predicted latent elements of \tilde{Y}_{(1,1)} is to apply fully connected layers followed by activation functions for 1-d vectorized input of all reference latents. An alternate is to use convolutional layers for the concatenated reference latents Ŷ_{(1,0)}(:,:, M−1), Ŷ_{(0,1)}(:, N−1, :), and Ŷ_{(0,0)}(:, N−1, M−1) as shown in FIG. 14 to utilize the advantage of parallel computation.

The present principles are not limited to use only concatenated latents of Ŷ_{(1,0)}(:,:, M−1), Ŷ_{(0,1)}(:, N−1, :), and Ŷ_{(0,0)}(:, N−1, M−1) as input. Additional information such as location information of the reference samples can be added as extra channels of the input.

Similar to FIG. 8 and FIG. 11, the concatenated latents are first transposed to be used as input to the 1-D convolutional layer, as shown in FIG. 14. Then, using the 1-D convolutional layer with 1×1 learned kernels as many as the number of output channels multiplied by input channels, O∈ [symbol] ^{N·M×C} can be produced. The rest of the process follows the same way described before.

### Spatially Selective Decoding/Reconstruction of Blocks

In an embodiment, pixel reconstruction for decoded latent blocks can be selectively done at the decoder without breaking the decoding process. Since the latent space intra prediction refers to adjacent blocks in the latent space domain, not the pixel domain, the prediction is possible as long as the latent blocks are correctly decoded for a given bitstream.

In this context, we introduce a method to enable or disable the second part of the decoding process, i.e., the synthesis of gₛ( ) of the output pixels from the decoded latent. A syntax element per block or a map at the image level can be transmitted to explicitly signal blocks that could be skipped for some applications. The decision to fully reconstruct each clock can also be made within the decoder system. For example, a Boolean signal is made when a target object is identified by running computer vision tasks on the decoded latent blocks.

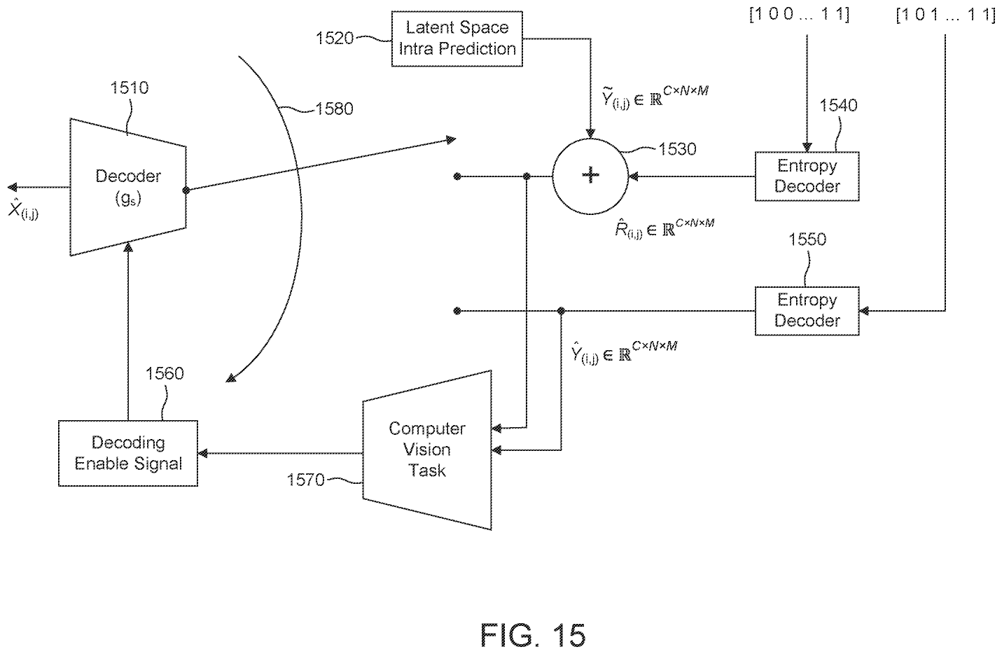

FIG. 15 presents a decoder system of our block-based end-to-end compression with latent space intra prediction, according to an embodiment. There are two paths to decode a latent block. One is to directly derive the reconstructed latent block from the bitstream through the entropy decoder (1550), the other is to reconstruct the latent block such that predicted latent \tilde{Y}_{(i,j)} via latent space intra prediction (1520) is added (1530) to the entropy decoded (1540) residual \hat{R}_{(i,j)} from the transferred bitstream. Therefore, the synthesis transformer gₛ( ) (1510) takes the decoded latent block selectively as input to transform latents into pixels. Selecting (1580) a decoded latent block as input can be indicated by a signaled flag in the bitstream or derived by a constraint between encoder and decoder.

In addition, gₛ( ) can also be enabled or disabled by a signal, Decoding Enable Signal (1560). In traditional image/video codecs, it is necessary to reconstruct all pixels because they are referenced by next coding blocks. However, in this application, reconstructing pixels is not necessary since latent space intra prediction refers to reconstructed latent of neighbors. The Decoding Enable Signal can be generated using the inference output of a computer vision task (1570) that takes the decoded latent as input. For example, in the case of a computer vision task like face detection, the task network can take the decoded latent as input to find face attributes from the input, then uses the Decoding Enable Signal to disable gₛ( ) so that the pixel reconstruction process for the face area is ignored to preserve privacy.

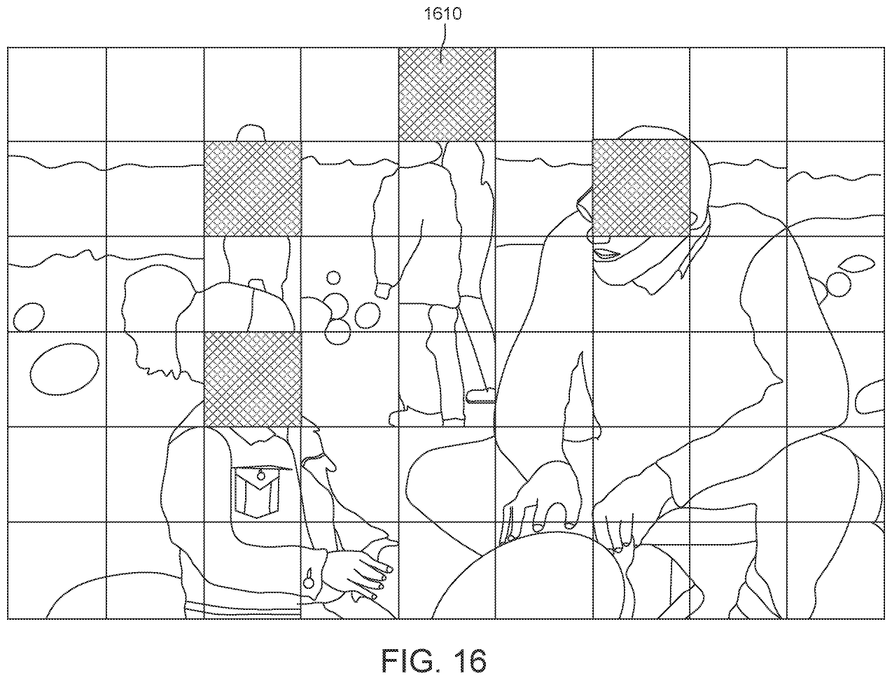

FIG. 16 demonstrates an example of use of Decoding Enable Signal by avoiding the reconstruction of some blocks (e.g., 1610) including face attributes while the remaining parts of the image are fully reconstructed as desired. Depending on the computer vision task network cooperating with the proposed coding system, the application can vary for different purposes. In FIG. 16, those blocks without pixel reconstruction are filled in with constant gray levels. It should be noted that other values can be used to fill in these blocks, for example, depending on the preference of the decoder.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, and inverse transformation. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video decoding, comprising:
decoding a residue block in a latent space for a block of a picture;
obtaining a predicted latent block for said block based on one or more neighboring latent blocks of said picture;
obtaining a latent block for said block, based on said residue block and said predicted latent block; and
inverse transforming said latent block for said block to reconstruct said block in a pixel domain.

2. The method of claim 1, further comprising:
determining that said block is to be reconstructed in said pixel domain, wherein said block is reconstructed in said pixel domain only if said block is determined to be reconstructed.

3. The method of claim 2, wherein a computer vision task is performed in order to determine that said block is to be reconstructed in said pixel domain.

4. (canceled)

5. The method of claim 1, wherein one or more convolution layers or one or more fully connected layers followed by activation functions are applied to obtain said predicted latent block.

6-9. (canceled)

10. The method of claim 1, for one neighboring latent block of said one or more neighboring latent_blocks, only a part of said one neighboring latent block is used to obtain said predicted latent block for said block.

11. (canceled)

12. A method of video encoding, comprising:
transforming a block of a picture into a latent block in a latent space for said block;
obtaining a predicted latent block for said block based on one or more neighboring latent blocks of said picture;
obtaining a residue block for said block in said latent space, based on said predicted latent block for said block and said latent block; and
encoding said residue block for said block.

13. The method of claim 12, wherein one or more fully connected layers or a sequence of convolutional layers with activation functions are used to transform said block into said latent block.

14. (canceled)

15. The method of claim 12, wherein one or more convolution layers are applied to obtain said predicted latent block.

16. The method of claim 12, wherein location information of said one or more neighboring latent blocks is used to obtain said predicted latent block.

17. (canceled)

18. The method of claim 12, for one neighboring latent block of said one or more neighboring latent blocks, only a part of a said one neighboring latent block is used to obtain said predicted latent block.

19-23. (canceled)

24. An apparatus, comprising one or more processors and at least one memory coupled to said one or more processors, wherein said one or more processors are configured to:
decode a residue block in a latent space for a block of a picture;
obtain a predicted latent block for said block based on one or more neighboring latent blocks of said picture;
obtain a latent block for said block based on said residue block and said predicted latent block; and
inverse transform said latent block for said block to reconstruct said block in a pixel domain.

25. The apparatus of claim 24, wherein said one or more processors are further configured to:
determine that said block is to be reconstructed in said pixel domain, wherein said block is reconstructed in said pixel domain only if said block is determined to be reconstructed.

26. The apparatus of claim 25, wherein a computer vision task is performed in order to determine that said block is to be reconstructed in said pixel domain.

27. The apparatus of claim 24, wherein one or more convolution layers or one or more fully connected layers followed by activation functions are applied to obtain said predicted latent block.

28. The apparatus of claim 24, for one neighboring latent block of said one or more neighboring latent blocks, only a part of said one neighboring latent block is used to obtain said predicted latent block for said block.

29. An apparatus, comprising one or more processors and at least one memory coupled to said one or more processors, wherein said one or more processors are configured to:
transform a block of a picture into a latent block in a latent space for said block;
obtain a predicted latent block for said block based on one or more neighboring latent blocks of said picture;
obtain a residue block for said block in said latent space based on said predicted latent block for said block and said latent block; and
encode said residue block for said block.

29. The apparatus of claim 29, wherein one or more fully connected layers or a sequence of convolutional layers with activation functions are used to transform said block into said latent block.

30. The apparatus of claim 29, wherein one or more convolution layers are applied to obtain said predicted latent block.

32. The apparatus of claim 29, wherein location information of said one or more neighboring latent blocks is used to obtain said predicted latent block.

33. The apparatus of claim 29, for one neighboring latent block of said one or more neighboring latent blocks, only a part of said one neighboring latent block is used to obtain said predicted latent block.
